(19) United States
(12) Patent Application Publication
(10) Pub. No.: US 2026/0234919 A1
(43) Pub. Date: Aug. 13, 2026

(54) OUTFLOW FILTER ASSEMBLY FOR A WATER FILTRATION SYSTEM AND A METHOD THEREFOR

(71) Applicant: Keegan Bosch, Henderson, NV (US)

(72) Inventor: Keegan Bosch, Henderson, NV (US)

(21) Appl. No.: 19/077,610

(22) Filed: Mar. 12, 2025

Related U.S. Application Data
(63) Continuation of application No. 19/051,726, filed on Feb. 12, 2025.

(51) Int. Cl. E03C 1/22; B01D 29/03

(52) U.S. Cl. CPC E03C 1/22; B01D 29/03; B01D 2029/033; E03C 2201/40

(57) ABSTRACT

An outflow filter assembly for a water filtration system includes a fitting, a filter unit, and a filter screen. The fitting includes a first fitting end designed to be coupled to a water filtration system and a second fitting end designed to be coupled to plumbing for flow of filtered water to plumbing outlets. The filter unit is inserted in the second fitting end. The filter unit is tubular and has a passage therein. The filter screen is positioned in the passage in the filter body. The filter screen is designed to filter out and trap particulate filter media in filtered water flowing out of the water filtration system to prevent entry of the particulate filter media into the plumbing when a filtration device in the water filtration system is compromised.

### (b) CROSS-REFERENCE TO RELATED APPLICATIONS

This application is a continuation-in-part of U.S. application Ser. No. 19/051,726, filed Feb. 12, 2025, which is incorporated by reference herein.

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to outflow fittings and filters and more particularly pertains to a new outflow filter assembly for preventing entry of particulate filter media into plumbing when a filtration device in a water filtration system is compromised, such as if the filtration device cracks or has a leak somewhere in its housing or filter membrane. In water filtration systems, water flows from an outside source into the plumbing in a building, such as a home or commercial building, into the filtration system, and then into the rest of the plumbing, which leads to the outlets, such as faucets and spigots and output pipes. The filtration device in the filtration system filters out impurities and minerals, usually by flowing the water through particulate filter media in the filtration device. The particulate filter media, such as activated carbon, is granular. In normal operation, some very fine particles of the particulate filter media can usually escape the filtration device, which particles are harmless and usually virtually undetectable. However, if the filtration device is compromised, such as by wear and tear or manufacturing defect, the larger particles or grains of the particulate filter media can escape into the water. These larger or visible particles are easily noticed to alert a person, such as a homeowner or building occupant, of the leakage, but by then the particulate filter media has spread throughout the plumbing, necessitating a flushing of the plumbing, including water tanks, which can be time-consuming and incomplete. The new outflow filter assembly traps these larger particles at the fitting connected to the water filtration system, thereby preventing these larger particles from entering the plumbing when the filtration device is compromised. The new outflow filter assembly can also trap the filter media in other locations, such as the bypass between the water filtration system and the fitting or other plumbing, or such as the flow unit at the top of the filter tank.

### (2) Description of Related Art Including Information Disclosed Under 37 CFR 1.97 and 1.98

The prior art relates to water filtration systems and filters. The prior art, as best understood, does not disclose an outflow filter assembly for a water filtration system that includes a filter screen designed to filter out and trap particulate filter media in filtered water flowing out of the water filtration system to prevent entry of the particulate filter media into the plumbing when a filtration device in the water filtration system is compromised. The filter screen can be positioned in a fitting, a bypass valve, or a flow unit of a water filtration system, which filter screen can be integrally formed as part of the fitting, the bypass valve, or the flow unit, or can be mounted in a filter unit that is inserted into the fitting, the bypass valve, or the flow unit.

### (h) BRIEF SUMMARY OF THE INVENTION

An embodiment of the disclosure meets the needs presented above in an outflow filter assembly for a water filtration system generally comprising a bypass valve and a filter screen. The bypass valve is designed to be coupled to a water filtration system for inflow of water from a water source into the water filtration system and for outflow of filtered water from the water filtration system into plumbing for flow of filtered water to plumbing outlets. The bypass valve is selectively adjustable to divert water from the water source to bypass the water filtration system and flow directly into the plumbing. The filter screen is positioned inside the bypass valve.

Another embodiment of the disclosure meets the needs presented above in an outflow filter assembly for a water filtration system generally comprising a flow unit and a filter screen. The flow unit is designed to be coupled to a water filtration tank of a water filtration system for inflow of water from a water source into the water filtration tank and for outflow of filtered water from the water filtration tank into plumbing for flow of filtered water to plumbing outlets. The filter screen is positioned inside the flow unit.

Yet another embodiment of the disclosure meets the needs presented above in an outflow filter assembly for a water filtration system generally comprising a fitting and a filter screen. The fitting includes a first fitting end is designed to be coupled to a water filtration system and a second fitting end is designed to be coupled to plumbing for flow of filtered water to plumbing outlets. The filter screen is positioned in the fitting.

Still another embodiment of the disclosure meets the needs presented above in an outflow filter assembly for a water filtration system generally comprising a filter unit and a filter screen. The filter screen is positioned in the filter unit, which filter unit is removably insertable into one of the bypass valve, the fitting, or the flow unit. The filter screen is designed to filter out and trap particulate filter media in filtered water flowing out of the water filtration system to prevent entry of the particulate filter media into the plumbing when a filtration device in the water filtration system is compromised.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a filter unit according to an embodiment of the disclosure.

FIG. 2 is a bottom perspective view of the filter unit of FIG. 1.

FIG. 3 is a top view of the filter unit of FIG. 1.

FIG. 4 is a side cross-sectional view of the filter unit of FIG. 1.

FIG. 5 is a top perspective view of an outflow filter assembly according to an embodiment of the disclosure.

FIG. 6 is a side cross-sectional view of an embodiment of the disclosure.

FIG. 7 is a side view of an embodiment of the disclosure in use.

FIG. 8 is a side view of an embodiment of the disclosure in use.

FIG. 9 is a side view of an embodiment of the disclosure in use.

FIG. 10 is a top perspective view of a filter unit of an embodiment of the disclosure.

FIG. 11 is a bottom perspective view of the filter unit of FIG. 10.

FIG. 12 is a side cross-sectional view of the filter unit of FIG. 10.

FIG. 13 is a side cross-sectional view of the filter unit of FIG. 10.

FIG. 14 is a top view of an embodiment of the disclosure.

FIG. 15 is a top view of an embodiment of the disclosure.

FIG. 16 is a side view of an embodiment of the disclosure.

FIG. 17 is a bottom perspective view of an embodiment of the disclosure.

### (J) DETAILED DESCRIPTION OF THE INVENTION

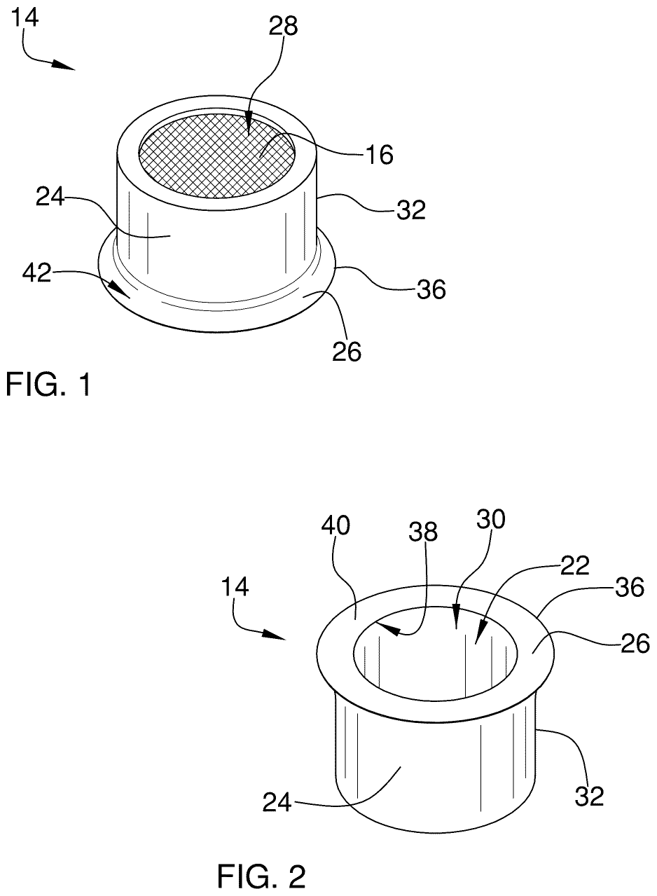

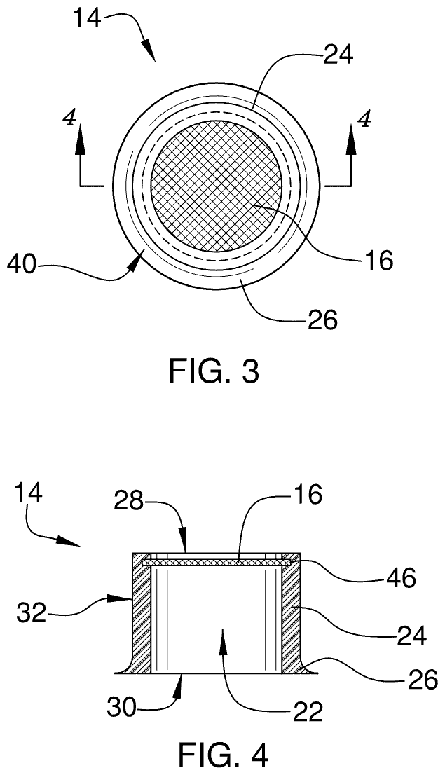

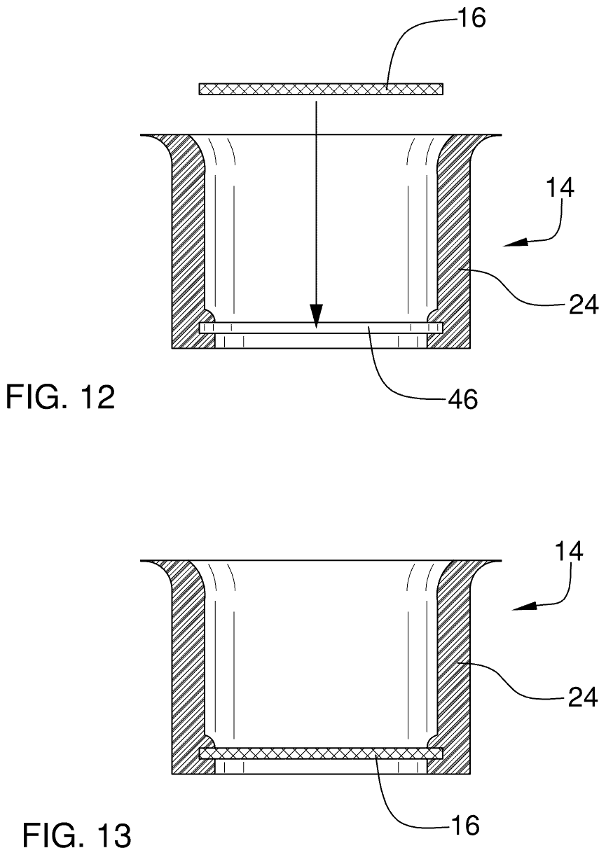

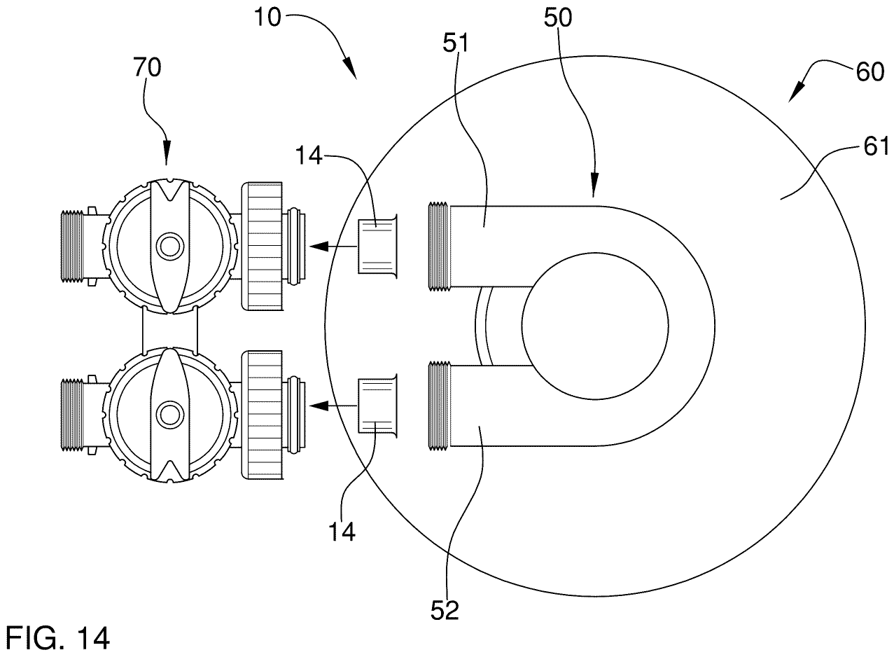

With reference now to the drawings, and in particular to FIGS. 1 through 17 thereof, a new outflow filter assembly embodying the principles and concepts of an embodiment of the disclosure and generally designated by the reference numeral 10 will be described.

As best illustrated in FIGS. 1 through 9, the outflow filter assembly 10 for a water filtration system 60 generally comprises a fitting 12, a filter unit 14, and a filter screen 16. The fitting 12 includes a first fitting end 18 designed to be coupled to a water filtration system 60 and a second fitting end 20 designed to be coupled to plumbing for flow of filtered water 64 to plumbing outlets. The filter unit 14 is inserted in the second fitting end 20. The filter unit 14 is tubular and has a passage 22 therein. The filter screen 16 is positioned in the passage 22 in the filter unit 14. The filter screen 16 is designed to filter out and trap particulate filter media 62 in filtered water 64 flowing out of the water filtration system 60 to prevent entry of the particulate filter media 62 into the plumbing when a filtration device 68 in the water filtration system 60 is compromised.

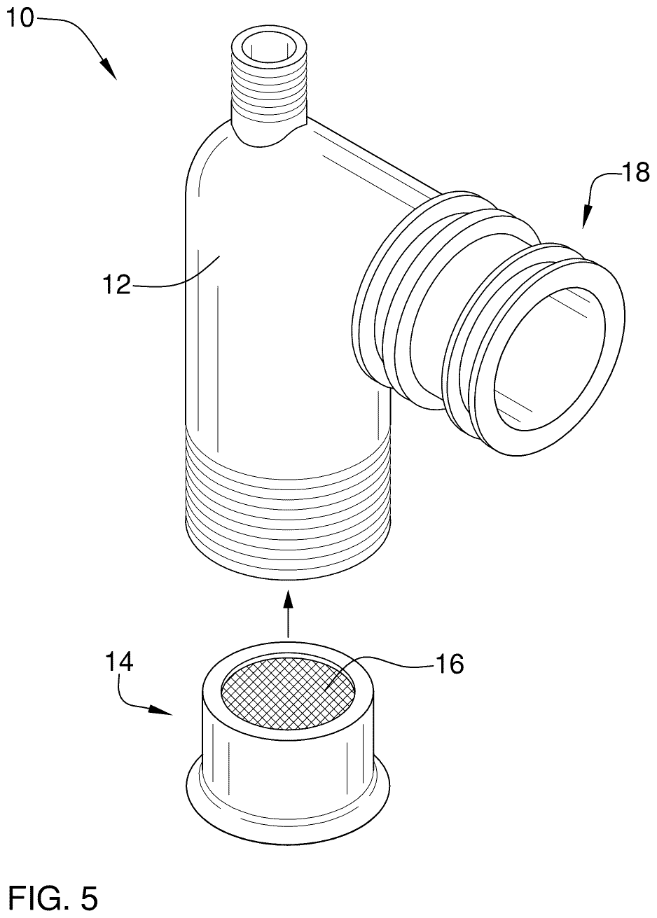

In the exemplary embodiment, as shown in FIGS. 5 through 9, the filter unit 14 is removable from the fitting 12 for removal of the particulate filter media 62 filtered and trapped by the filter screen 16. The user therefore does not need to disconnect the fitting 12 from the water filtration system 60 in order to clean any of the particulate filter media 62 out of the filter screen 16, the filter unit 14, and the fitting 12. It should be noted that the fitting 12 shown in the figures is only one exemplary embodiment of the fitting 12. The filter unit 14 can be designed for and used with various types of fittings.

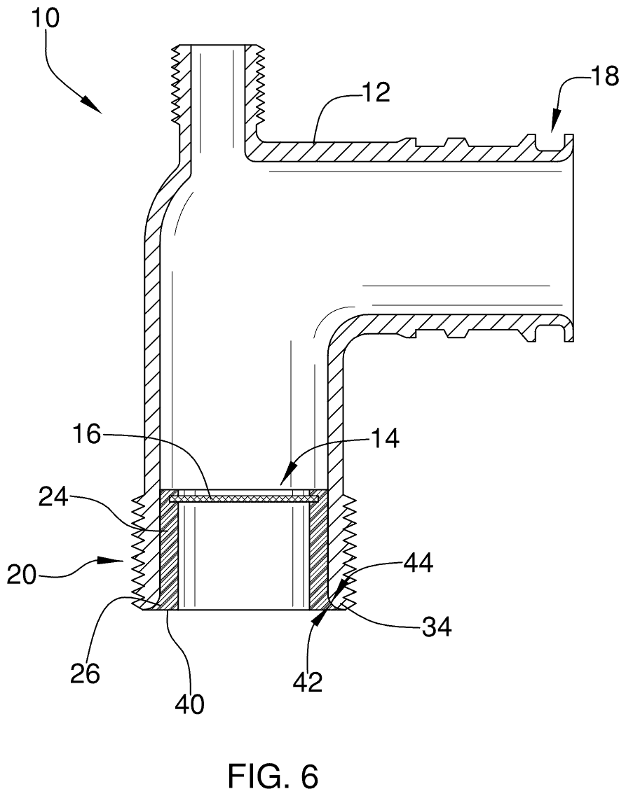

The filter unit 14 includes a body portion 24 and a lip portion 26. The body portion 24 includes a first aperture 28 and a second aperture 30. The lip portion 26 is positioned about the second aperture 30. The lip portion 26 is designed to project annularly beyond an outer wall surface 32 of the body portion 24. As shown in FIG. 6, the lip portion 26 is seated against a rim 34 of the second fitting end 20. The lip portion 26 prevents the filter unit 14 from being pushed completely into the fitting 12 and promotes a seal against leakage of water.

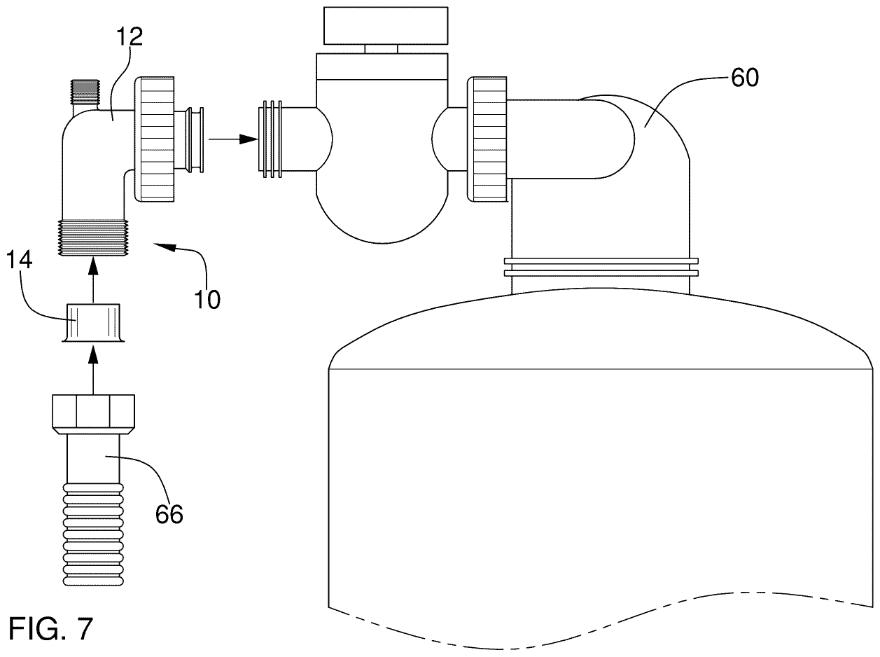

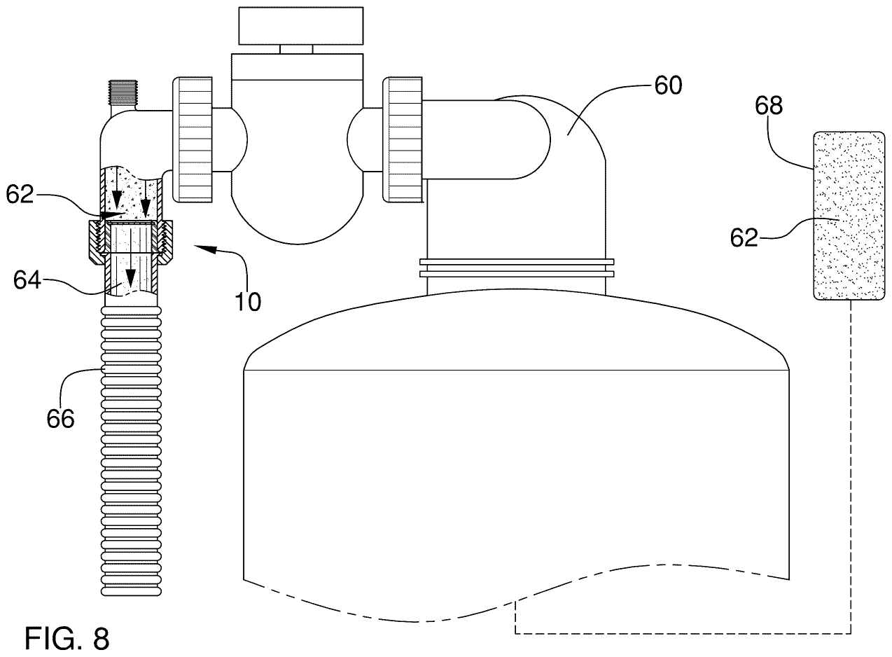

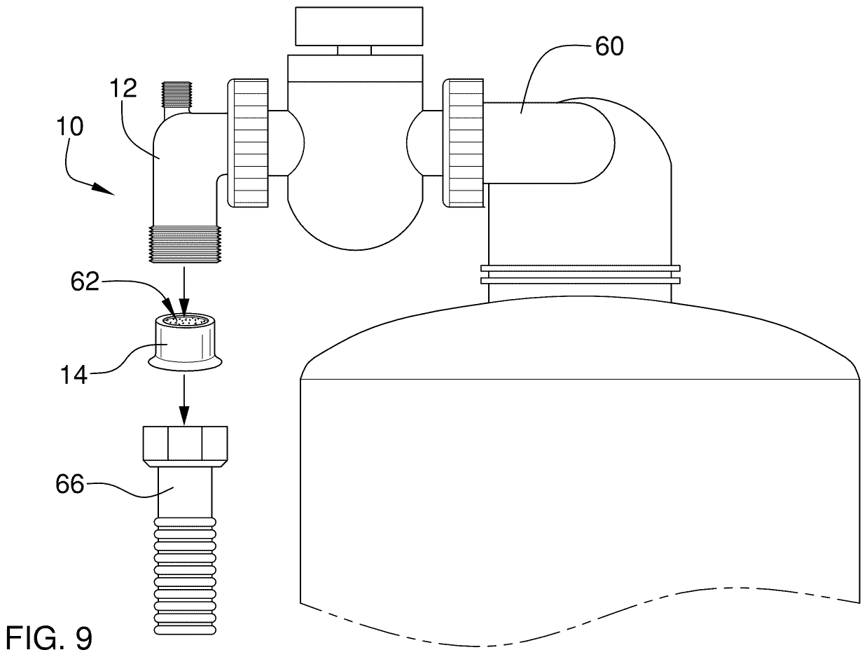

In the exemplary embodiment, the lip portion 26 includes an outer lip edge 36, an inner lip edge 38, and a lip end face 40 between the outer lip edge 36 and the inner lip edge 38. The lip portion 26 includes an outer lip surface 42 from the outer lip edge 36 to the outer wall surface 32 of the body portion 24. The outer lip surface 42 is concave and designed to follow an inner surface 44 of the rim 34 of the second fitting end 20 that is convex, such that the lip end face 40 is positioned flush with the rim 34 of the second fitting end 20. As shown in FIG. 6, the rim 34 of the second fitting end 20 is convex or rounded, so the outer lip surface 42 is concave or rounded to produce a matching engagement and seal. This design also allows the filter unit 14 to be seated essentially completely within the fitting 12 such that the filter unit 14 does not project out of the fitting 12, or at least projects out minimally, such that the lip end face 40 is flush with the rim 34 of the second fitting end 20. This design allows a section of the plumbing, such as a flex hose 66 shown in FIGS. 7 through 9, to couple with the second fitting end 20 without any interference from the filter unit 14. As shown in FIG. 8, for example, the flex hose 66 is fully screwed onto the second fitting end 20 in a fully sealed engagement. However, in another possible embodiment, the lip portion 26 of the filter unit 14 could be rectangular or have squared corners, depending on the design of the rim 34 of the second fitting end 20. The lip portion 26 of the filter unit 14 could also include a seal, like an O-ring or similar. The lip portion 26 of the filter unit 14 can be modified as needed during manufacture to best seal the type of the fitting 12 into which in the filter unit 14 will be inserted.

In the exemplary embodiment in FIG. 1, the filter screen 16 is positioned at the first aperture 28. In another possible embodiment, the filter screen 16 is positioned at the second aperture 30, or could be positioned at any location in a central portion of the body portion 24 of the filter unit 14. In the exemplary embodiment in FIG. 4, the filter unit 14 includes an annular recess 46 in an inner wall surface of the body portion 24 adjacent the first aperture 28. The filter screen 16 is mounted in the annular recess 46. In another possible embodiment, the filter screen 16 could be formed integrally with or bonded to the body portion 24 of the filter unit 14.

As discussed above, the filter screen 16 is designed to filter out and trap the particulate filter media 62. In one embodiment, the filter screen 16 is designed to filter out and trap the particulate filter media 62 having a particle size of 0.15 mm to 1.0 mm. In another embodiment, the filter screen 16 is designed to filter out and trap the particulate filter media 62 having a particle size of 0.3 mm to 0.8 mm. The filter screen 16 can be selected to filter out and trap the particulate filter media 62 of whatever size is appropriate for the particulate filter media 62 to be trapped.

The filter unit 14 is made of plastic, though in another possible embodiment the filter unit 14 could be made of metal or a combination of metal and plastic. The filter screen 16 is made of metal, plastic, or a combination of metal and plastic. The filter unit 14 could be made of a plastic or elastomer, such as soft or resilient plastic or elastomer, to promote a friction fit or form fit with the fitting 12 to retain the filter unit 14 in the fitting 12.

The outflow filter assembly 10 is used to prevent entry of the particulate filter media 62 into the plumbing when the filtration device 68 in the water filtration system 60 is compromised, such as if the filtration device 68 cracks or has a leak somewhere in its housing or filter membrane. In such a situation, the larger grains of the particulate filter media 62, such as activated carbon, in the filtration device 68 are allowed to escape into the water flowing through the water filtration system 60. As shown in the exemplary embodiment in FIGS. 7 through 9, the first fitting end 18 of the fitting 12 is coupled to the water filtration system 60. A flexible hose is connected to plumbing and coupled to the second fitting end 20 of the fitting 12. The water filtration system 60 is then operated as normally to flow filtered water 64 into the plumbing. If the filtration device 68 is compromised, the filter screen 16 filters out and traps the particulate filter media 62 with the filter screen 16 and thereby prevents trapped particulate filter media 62 from entering the plumbing. As discussed above, without the filter screen 16, the particulate filter media 62 would freely flow throughout the plumbing. At some point after the filtration device 68 is compromised and leaking the particulate filter media 62, a person, such as a homeowner or commercial building occupant, will either detect a leak of particulate filter media 62 out of a filtration device 68 in the water filtration system 60, such as by seeing an increased amount of fine particles of the particulate filter media 62, small enough to pass through the filter screen 16, in the filtered water 64 exiting the plumbing outlets, such as a faucet or spigot, or will detect a reduced flow of filtered water 64 out of the plumbing, indicating that the particulate filter media 62 has accumulated at the filter screen 16 and is inhibiting flow of filtered water 64. The user or a service technician can then turn off flow of water through the fitting 12 and decouple the flexible hose from the fitting 12. The filter unit 14 is then inspected and any particulate filter media 62 trapped in the filter unit 14 and the fitting 12 is cleaned out. The user or the service technician can then repair the water filtration system 60, such as by replacing the filtration device 68, then reassemble and reconnect any disconnected parts to operate the water filtration system 60 as normal. In the exemplary embodiment, in FIGS. 7 through 9, the filter unit 14 can be removed from the fitting 12, cleaned out of any of the particulate filter media 62, and then inserted back into the fitting 12, all without decoupling or disconnecting the fitting 12 from the water filtration system 60.

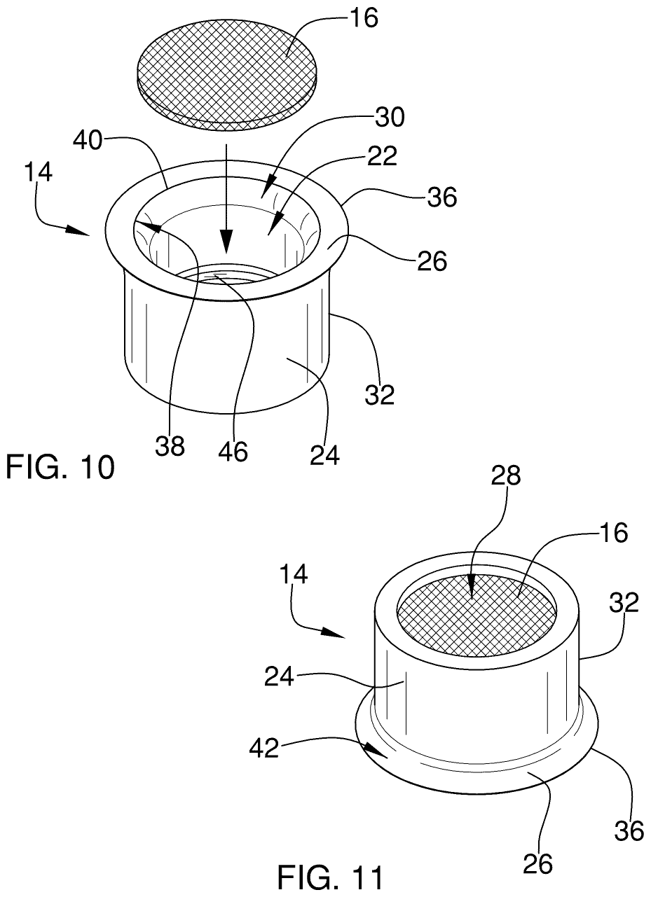

FIGS. 10 through 17 show additional embodiments and variations of the overall design and components of the outflow filter assembly 10. In FIGS. 10 through 13, the filter screen 16 is a separate from the filter unit 14 and can be removably inserted in the filter unit 14, specifically in the annular recess in the body portion 24. However, this is only one possible embodiment, and in another possible embodiment, the filter screen 16 is bonded to or otherwise integrally formed with the filter unit 14, such that the filter screen 16 is not removable without damaging the filter unit 14 and/or the filter screen 16.

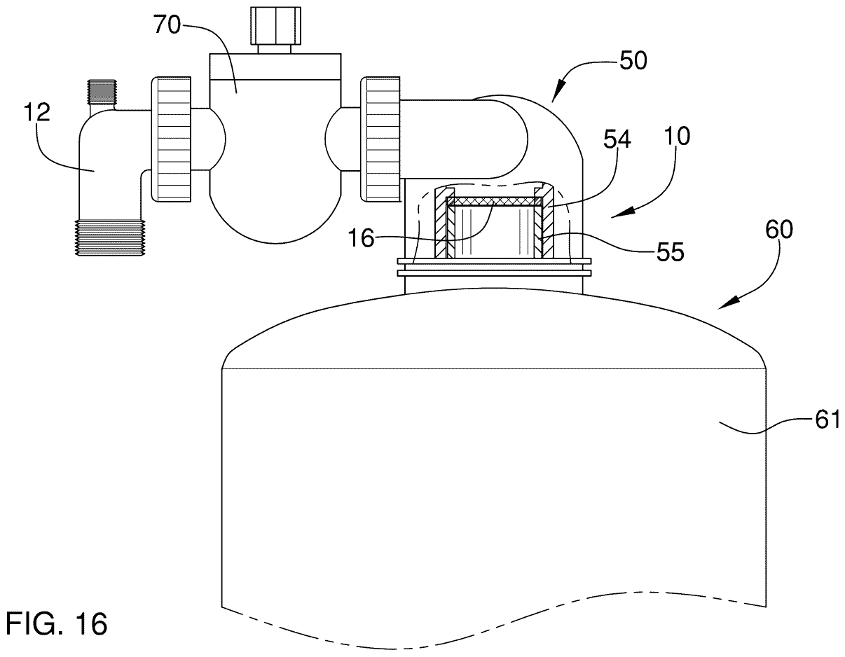

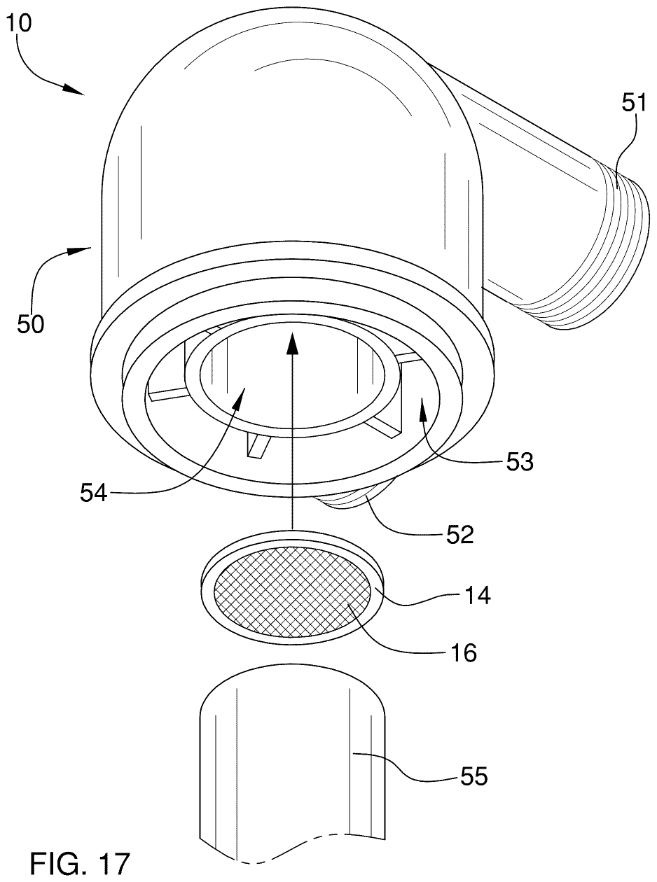

FIGS. 16 and 17 show an alternative design for the filter unit 14. In this embodiment, the filter unit 14 is a flat ring. The filter unit 14 of this design is insertable into pipes, conduits, or passages, either in a removable manner or permanently installed. It should be understood that the filter unit 14 having this ring-shaped design is usable or adaptable for use in any of the embodiments of the outflow filter assembly 10 disclosed herein or shown in the figures. Likewise, the filter unit 14 having the tubular or cup-shaped design in FIGS. 1 through 15 is usable or adaptable for use in any of the embodiments of the outflow filter assembly 10 disclosed herein or shown in the figures. Any number of the filter units 14 of either configuration, or possibly even a different configuration, are usable in an embodiment of the outflow filter assembly 10 in order to prevent flow of particulate filter media 62 into the plumbing.

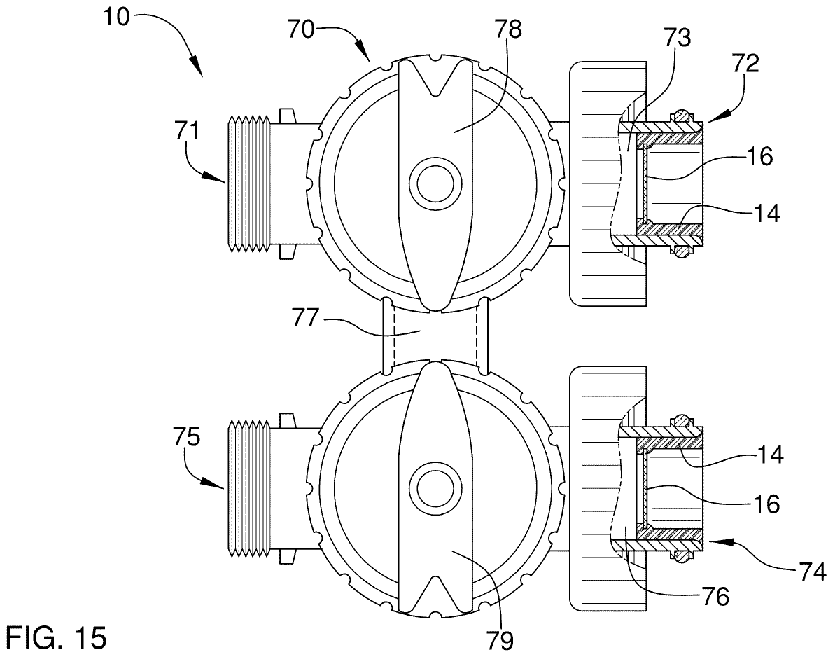

FIGS. 14 and 15 show another possible embodiment of the outflow filter assembly 10 that includes a bypass valve 70 and the filter screen 16. The bypass valve 70 is designed to be coupled to a water filtration system 60 for inflow of water from a water source into the water filtration system 60 and for outflow of filtered water from the water filtration system 60 into plumbing for flow of filtered water to plumbing outlets. The bypass valve 70 is selectively adjustable to divert water from the water source to bypass the water filtration system 60 and flow directly into the plumbing. The filter screen 16 is positioned inside the bypass valve 70. In one possible embodiment, the filter screen 16 is integrally formed inside the bypass valve 70, whereas in another possible embodiment the filter screen 16 is mounted in the filter unit 14, which is inserted into the bypass valve 70.

The bypass valve 70 has a common design well known in the plumbing arts, though the embodiment shown in FIGS. 14 and 15 is only one possible design, and it should be understood that the invention is useful in virtually any style of bypass valve 70 or bypass assembly. In the exemplary embodiment, a first bypass inlet 71 is designed to be coupled to the water source. A first bypass outlet 72 is designed to be coupled to a flow inlet 51 of a flow unit 50 of the water filtration system 60. An inlet conduit 73 connects the first bypass inlet 71 and the first bypass outlet 72. A second bypass inlet 74 is designed to be coupled to a flow outlet 52 of the flow unit 50 of the water filtration system 60. A second bypass outlet 75 is designed to be coupled to the plumbing, in this case the fitting 12. An outlet conduit 76 connects the second bypass inlet 74 and the second bypass outlet 75. A bypass conduit 77 is oriented perpendicular to and connects the inlet conduit 73 and the outlet conduit 76. An inlet valve 78 is positioned at the intersection of the inlet conduit 73 and the bypass conduit 77. An outlet valve 79 is positioned at the intersection of the outlet conduit 76 and the bypass conduit 77. For simplicity, only the handles of the inlet valve 78 and the outlet valve 79 are shown as such valves are well known. The inlet valve 78 is selectively adjustable to change the inflow of water from the first bypass inlet 71 to either the first bypass outlet 72 or to the bypass conduit 77. The outlet valve 79 is selectively adjustable to change the outflow of water to the second bypass outlet 75 from either the second bypass inlet 74 or from the bypass conduit 77. In FIG. 15, the handles are turned parallel to the bypass conduit 77, indicating that water will not flow into the water filtration system 60, but rather be diverted such that water flows into the first bypass inlet 71, then through the bypass conduit 77, and then out the second bypass outlet 75. As is well known in the plumbing arts, the handles can be rotated 90 degrees such that each of the handles is aligned with its respective one of the inlet conduit 73 and the outlet conduit 76, which would switch the flow of water into the water filtration system 60, specifically into the inlet conduit 73, then through the water filtration tank 61, and then out through the outlet conduit 76.

The filter screen 16 can be positioned in the outlet conduit 76. This way, if the particulate filter media 62 is flowing out of the water filtration system 60, the filter screen 16 will capture the particulate filter media 62 before it exits the bypass valve 70. Once a user detects a reduced or stopped flow of filtered water, the user will know the filter screen 16 is likely clogged with the particulate filter media 62. In the exemplary embodiment shown in FIG. 15, the filter screen 16 is positioned between the outlet valve 79 and the second bypass inlet 74. Due to this positioning, the user can switch the inlet valve 78 and the outlet valve 79 to place the bypass valve 70 in bypass mode and resume flow of water from the outside source to the plumbing outlets. Water will flow freely via the bypass valve 70 while the particulate filter media 62 remains trapped in the filter screen 16. This way the user can prevent the particulate filter media 62 from flowing throughout the building plumbing, but still have normal flow of water, though not filtered water.

In this exemplary embodiment, an additional filter screen 16 is positioned in the inlet conduit 73. The additional filter screen 16 is positioned between the inlet valve 78 and the first bypass outlet 72. The additional filter screen 16 is effectively a backup in case the bypass valve 70 is inadvertently installed backwards, such that filtered water is flowing out through the inlet conduit 73.

In the exemplary embodiment in FIG. 15, the filter screen 16 is removably mounted in the filter unit 14 according to the design in FIGS. 10 through 13. However, in another possible embodiment, the filter unit 14 according to FIG. 1 could be used or the ring-shaped filter unit 14 shown in FIG. 17 could be used.

In the exemplary embodiment in FIG. 17, the outflow filter assembly 10 includes the flow unit 50 and the filter screen 16. As shown in FIG. 16, the flow unit 50 is designed to be coupled to a water filtration tank 61 of the water filtration system 60 for inflow of water from a water source into the water filtration tank 61 and for outflow of filtered water from the water filtration tank 61 into plumbing for flow of filtered water to plumbing outlets. As shown in FIG. 16, the filter screen 16 is positioned inside the flow unit 50. In one possible embodiment, the filter screen 16 is integrally formed inside the flow unit 50, whereas in another possible embodiment the filter screen 16 is mounted in the filter unit 14, which is inserted into the flow unit 50. The filter unit 14 in this embodiment is the ring-shaped design shown in FIG. 17.

In the exemplary embodiment in FIG. 17, the flow unit 50 includes an inlet flow passage 53 for inlet of water into the water filtration tank 61 and an outlet flow passage 54 for outlet of water out of the water filtration tank 61. As shown in FIG. 17, the inlet flow passage 53 is a ring-shaped passage positioned about the outlet flow passage 54, which is in the form of a pipe or tube. An outlet pipe 55 connects the water filtration tank 61 to the outlet flow passage 54. The filter unit 14 and filter screen 16 are inserted a distance into the outlet flow passage 54 such that the outlet pipe 55 can also be inserted into the outlet flow passage 54. In another possible embodiment, the filter screen 16 could be integrally formed in or as part of the outlet flow passage 54. In yet another possible embodiment, the filter screen 16 could also be installed in the inlet flow passage 53 as a backup in case of backwards installation, wherein the filter screen 16 could be configured as a disk or a ring depending on the design of the inlet flow passage 53.

In another possible embodiment, the outflow filter assembly 10 includes only the fitting 12 and the filter screen 16, with or without the filter unit 14. The filter screen 16 is positioned in the fitting 12. In one possible embodiment, the filter screen 16 is integrally formed inside the fitting 12, whereas in another possible embodiment the filter screen 16 is mounted in the filter unit 14, which is inserted into the fitting 12.

It should be noted that the phrase “outflow filter assembly” as used herein is intended to generally refer to any assembly of components that can be used to prevent the particulate filter media 62 from entering the building plumbing. Therefore, the outflow filter assembly 10 could refer to any of the embodiments disclosed herein or obvious variations thereof, such as, but not limited to, the fitting 12 with one or more of the filter screens 16 integrally mounted therein or removably mounted via the filter unit 14, the bypass valve 70 with one or more of the filter screens 16 integrally mounted therein or removably mounted via the filter unit 14, the flow unit 50 with one or more of the filter screens 16 integrally mounted therein or removably mounted via the filter unit 14, or the filter screen 16 integrally or removably mounted in the filter unit 14 that is designed to be inserted into any one of the fitting 12, the flow unit 50, or the bypass valve 70. Therefore, the fitting 12, the flow unit 50, and the bypass valve 70 could be manufactured and sold as a single unit with the filter screen 16 as an integral part thereof, or the filter screen 16 and filter unit 14 could be manufactured and sold as a standalone insert for use in any one of the fitting 12, the flow unit 50, and the bypass valve 70, or the filter screen 16 and filter unit 14 could be sold with any one of the fitting 12, the flow unit 50, and the bypass valve 70 as a kit or assembly.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An outflow filter assembly for a water filtration system comprising:
a bypass valve, the bypass valve being configured to be coupled to a water filtration system for inflow of water from a water source into the water filtration system and for outflow of filtered water from the water filtration system into plumbing for flow of filtered water to plumbing outlets, the bypass valve being selectively adjustable to divert water from the water source to bypass the water filtration system and flow directly into the plumbing; and
a filter screen, the filter screen being positioned inside the bypass valve, the filter screen being configured to filter out and trap particulate filter media in the filtered water flowing out of the water filtration system to prevent entry of the particulate filter media into the plumbing when a filtration device in the water filtration system is compromised.

2. The outflow filter assembly of claim 1, wherein:
the bypass valve includes:
a first bypass inlet being configured to be coupled to the water source;
a first bypass outlet being configured to be coupled to a flow inlet of a flow unit of the water filtration system;
an inlet conduit connecting the first bypass inlet and the first bypass outlet;
a second bypass inlet being configured to be coupled to a flow outlet of the flow unit of the water filtration system;
a second bypass outlet being configured to be coupled to the plumbing;
an outlet conduit connecting the second bypass inlet and the second bypass outlet;
a bypass conduit oriented perpendicular to and connecting the inlet conduit and the outlet conduit;
an inlet valve positioned at the intersection of the inlet conduit and the bypass conduit, the inlet valve being selectively adjustable to change the inflow of water from the first bypass inlet to either the first bypass outlet or to the bypass conduit; and
an outlet valve positioned at the intersection of the outlet conduit and the bypass conduit, the outlet valve being selectively adjustable to change the outflow of water to the second bypass outlet from either the second bypass inlet or from the bypass conduit; and
the filter screen is positioned in the outlet conduit.

3. The outflow filter assembly of claim 2, wherein the filter screen is positioned between the outlet valve and the second bypass inlet.

4. The outflow filter assembly of claim 2, further comprising an additional filter screen positioned in the inlet conduit.

5. The outflow filter assembly of claim 3, further comprising an additional filter screen positioned in the inlet conduit.

6. The outflow filter assembly of claim 5, wherein the additional filter screen is positioned between the inlet valve and the first bypass outlet.

7. The outflow filter assembly of claim 2, further comprising a filter unit, the filter unit being removably inserted in the bypass valve, the filter unit including a passage in which the filter screen is mounted.

8. The outflow filter assembly of claim 7, wherein the filter unit is a flat ring.

9. The outflow filter assembly of claim 7, wherein:
the filter unit is tubular and includes a body portion and a lip portion;
the body portion includes a first aperture and a second aperture;
the lip portion is positioned about the second aperture;
the lip portion is configured to project annularly beyond an outer wall surface of the body portion;
the lip portion is seated against a rim of the second bypass inlet; and
the filter screen is positioned at the first aperture.

10. The outflow filter assembly of claim 6, further comprising:
a filter unit, the filter unit being removably inserted in the bypass valve, the filter unit including a passage in which the filter screen is mounted; and
an additional filter unit, the additional filter screen being mounted in the additional filter unit.

11. The outflow filter assembly of claim 10, wherein each of the filter unit and the additional filter unit is a flat ring.

12. The outflow filter assembly of claim 10, wherein:
each of the filter unit and the additional filter unit is tubular and includes a body portion and a lip portion;
the body portion includes a first aperture and a second aperture;
the lip portion is positioned about the second aperture;
the lip portion is configured to project annularly beyond an outer wall surface of the body portion; and
the lip portion is seated against a rim of the second bypass inlet.

13. An outflow filter assembly for a water filtration system comprising:
a flow unit, the flow unit being configured to be coupled to a water filtration tank of a water filtration system for inflow of water from a water source into the water filtration tank and for outflow of filtered water from the water filtration tank into plumbing for flow of filtered water to plumbing outlets; and
a filter screen, the filter screen being positioned inside the flow unit, the filter screen being configured to filter out and trap particulate filter media in the filtered water flowing out of the water filtration tank to prevent entry of the particulate filter media into the plumbing when a filtration device in the water filtration system is compromised.

14. The outflow filter assembly of claim 13, wherein:
the flow unit includes:
an inlet flow passage for inlet of water into the water filtration tank; and
an outlet flow passage for outlet of water out of the water filtration tank; and
the filter screen is positioned in the outlet flow passage.

15. The outflow filter assembly of claim 14, further comprising a filter unit, the filter unit being removably inserted in outlet flow passage, the filter unit including a passage in which the filter screen is mounted, the filter unit is a flat ring.

16. An outflow filter assembly for a water filtration system comprising:
a fitting, the fitting including a first fitting end being configured to be coupled to a water filtration system and a second fitting end being configured to be coupled to plumbing for flow of filtered water to plumbing outlets; and
a filter screen, the filter screen being positioned in the fitting, the filter screen being configured to filter out and trap particulate filter media in filtered water flowing out of the water filtration system to prevent entry of the particulate filter media into the plumbing when a filtration device in the water filtration system is compromised.

17. The outflow filter assembly of claim 16, further comprising a filter unit, the filter unit being removably inserted in the fitting, the filter unit including a passage in which the filter screen is mounted.

18. The outflow filter assembly of claim 17, wherein:
the filter unit includes a body portion and a lip portion;
the body portion includes a first aperture and a second aperture;
the lip portion is positioned about the second aperture;
the lip portion is configured to project annularly beyond an outer wall surface of the body portion; and
the lip portion is seated against a rim of the second fitting end.

19. The outflow filter assembly of claim 18, wherein the filter screen is positioned at the first aperture.
